(19) United States
(12) Patent Application Publication
(10) Pub. No.: US 2013/0136221 A1
(43) Pub. Date: May 30, 2013

(54) METHOD OF PRODUCING RADIOACTIVE MOLYBDENUM

(71) Applicant: JAPAN ATOMIC ENERGY AGENCY, Ibaraki (JP)

(72) Inventors: Kaori NISHIKATA, Higashi-ibaraki (JP); Akihiro KIMURA, Higashi-ibaraki (JP); Takuya ISHIDA, Higashi-ibaraki (JP); Shigeru KITAGISHI, Higashi-ibaraki (JP); Kunihiko TSUCHIYA, Higashi-ibaraki (JP); Hiroaki AKIYAMA, Hiki (JP); Masaaki NAGAKURA, Hiki (JP); Kunihiko SUZUKI, Hiki (JP)

(73) Assignee: JAPAN ATOMIC ENERGY AGENCY, Ibaraki (JP)

(21) Appl. No.: 13/675,769

(22) Filed: Nov. 13, 2012

(30) Foreign Application Priority Data
Nov. 14, 2011 (JP) 2011248993
May 29, 2012 (JP) 2012121785

(51) Int. Cl. G21G 1/00

(52) U.S. Cl. CPC G21G 1/001
USPC 376/186

(57) ABSTRACT

To provide a method of producing radioactive molybdenum solution suitable for extracting ^{99m}Tc to be used as radioactive diagnostic drug by way of establishing a production process for high-density MoO₃ pellets with a lower amount of insoluble content when dissolving the pellets. The method has the steps of: preparing MoO₃ powder, fabricating a MoO₃ pellet by filling said MoO₃ powder in a heated die and sintering in an air, oxidizing said MoO₃ pellet, producing neutron-irradiated MoO₃ pellets by irradiating a neutron on said oxidized MoO₃ pellet, and obtaining radioactive molybdenum solution by dissolving said neutron-irradiated MoO₃ pellet.

### BACKGROUND OF THE INVENTION

Present invention relates to a method of producing radioactive molybdenum (⁹⁹Mo) as the parent nuclide of technetium-99m (^{99m}Tc), a radioactive diagnostic drug indispensable for the image diagnosis of diseases such as cancer, myocardial infarction, cerebral apoloplexy and others, by neutron irradiation with ⁹⁸Mo as the raw material.

^{99m}Tc may be generated due to β⁻ decay of ⁹⁹Mo as its parent nuclide. (n, γ) method of producing ⁹⁹Mo by neutron irradiation with ⁹⁸Mo being as the raw material is known as one of the methods for producing ⁹⁹Mo. (n, γ) method is such a method that a solid substance including natural molybdenum (for example, MoO₃ pellet) may be placed inside the irradiation container (hereinafter referred to as “rabbit”), and in a nuclear reactor, and then ⁹⁹Mo may be produced due to neutron capture reaction (⁹⁸Mo (n, γ) ⁹⁹Mo reaction).

In the production of radioactive molybdenum (⁹⁹Mo) by a (n, γ) method, in which the processes after neutron irradiation include at most an extraction of MoO₃ pellet from the rabbit and a dissolution of the pellets, there is such an advantage that the amount of radioactive waste is smaller in contrast to (n, f) method, which is one of the other production methods for radioactive molybdenum. The production cost of ⁹⁹Mo is as low as 0.83 US$ for 37 GBq. However, as the fraction of ⁹⁹Mo generated by the (n, γ) method may be reduced due to the existence of molybdenum elements with the different mass numbers, its specific radioactivity is disadvantageously from 37 to 74 GBq/g-Mo being lower than that in (n, f) method. This is the reason why it is required to increase the production amount of ⁹⁹Mo.

In order to increase the production amount of ⁹⁹Mo, it is required to make the best use of high-density MoO₃ pellets as the irradiation target for the various reasons. As for the production method of MoO₃ pellets, what have been used are several methods including uniaxial pressing method, hot pressing method, hot isostatic pressing method, and plasma sintering method and others. For example, Patent Document 1, which discloses an invention aimed for achieving the similar object to that of the present invention, discloses a method of producing high-density MoO₃ pellets by Spark Plasma Sintering (SPS) method, one of plasma sintering methods. In the method according to Patent Document 1, high-density MoO₃ pellets may be produced by SPS method under the condition for the sintering temperature from 540 to 640° C. in a vacuum.

[Patent Document 1] JP 2010-175409 A

### BRIEF SUMMARY OF THE INVENTION

In general, there is such a disadvantage as low sintering density in MoO₃ pellets produced by uniaxial pressing method, hot-press method and hot isostatic pressing method, being used generally as the production method of ceramics. In those methods, it is also required to add binders such as camphor, polyvinyl alcohol (PVA) and the like when forming MoO₃ pellets, which may leads to some potential for impurities being mixed in MoO₃ pellets. Though MoO₃ pellets produced by SPS method may have the sintering density as high as about 95% as disclosed in Patent Document 1, this method may be not always satisfactory for extracting ^{99m}Tc to be used as the diagnostic drug because of such problems that a longer duration time may be required for dissolving high-density MoO₃ pellets produced according to this method with sodium hydroxide (NaOH) solution, and that there may remain a large amount of insoluble content.

An object of the present invention is to provide a method of producing radioactive molybdenum solution suitable for extracting ^{99m}Tc to be used as the radioactive diagnostic drug by way of establishing a production process for high-density MoO₃ pellets with a lower amount of insoluble content when dissolving the pellets.

In one aspect of the present invention, the production method of radioactive molybdenum solution comprises five steps including; a step of preparing MoO₃ powder, a step of fabricating MoO₃ pellets by sintering said MoO₃ powder in a heated die, a step of oxidizing said MoO₃ pellets, a step of producing neutron-irradiated MoO₃ pellets including ⁹⁹Mo by neutron irradiation on said oxidized MoO₃ pellets, and a step of obtaining radioactive molybdenum solution by dissolving said neutron-irradiated MoO₃ pellets.

What is provided is a producing method of radioactive molybdenum solution in which the step of oxidizing MoO₃ pellets obtained in said fabricating step enables to reduce the amount of insoluble content as much as possible by means that MoO₃ pellets may be exposed in ozone gas at the reaction temperature range equal to or higher than the room temperature or equal to or less than 120° C., or baked preliminarily in the air at the temperature equal to or higher than 350° C. and equal to or less than 500° C.

In another aspect of the present invention, a producing method of radioactive molybdenum solution includes a step of preparing MoO₃ powder, a step of fabricating MoO₃ pellets by sintering said MoO₃ powder in a heated die in the air at the temperature equal to or more than 500° C. and less than 540° C. by plasma sintering method, a step of oxidizing said MoO₃ pellets, a step of producing neutron-irradiated MoO₃ pellets by irradiating neutrons on said oxidized MoO₃ pellets, and a step of obtaining radioactive molybdenum solution by dissolving said neutron-irradiated MoO₃ pellets.

Either of an SPS method or a Plasma Activated Sintering (PAS) method may be applied as plasma sintering method used in the present invention, in which MoO₃ pellets may be sintered in the air.

### EFFECT OF THE INVENTION

According to the present invention, it will be appreciated that the amount of insoluble content may be reduced substantially, and that a high-quality radioactive diagnostic drug may be obtained finally by means that a step of oxidizing the fabricated MoO₃ pellets after fabricating MoO₃ pellets is placed as the preceding step before the step of obtaining radioactive molybdenum solution by dissolving said neutron-irradiated MoO₃ pellets.

### BRIEF DESCRIPTION OF THE DRAWINGS

FIG. 1 is a flow chart illustrating the method of producing radioactive molybdenum solution.

FIG. 2 is a schematic diagram of an apparatus for sintering MoO₃ pellets by a plasma sintering method.

FIG. 3 is a graph showing the correlation between the sintering density and the sintering temperature in MoO₃ pellets when applying the plasma sintering method.

FIG. 4 is a schematic diagram of an apparatus for oxidizing MoO₃ pellets.

FIG. 5 is a graph showing the temperature dependency of Ozone gas concentration.

FIG. 6 is a schematic diagram of an apparatus for dissolving neutron-irradiated MoO₃ pellets.

FIG. 7 is a table showing the test result of oxidization process by using ozone gas exposure and dissolving process of MoO₃ pellets.

FIG. 8 is a table showing the characteristic test result of oxidization process of MoO₃ pellets in the high-temperature air.

FIG. 9 is a photograph of MoO₃ pellets finished by oxidization process in the air at 350° C. for two hours and the solution in which MoO₃ pellets are dissolved by 6M NaOH.

### DETAILED DESCRIPTION OT THE INVENTION

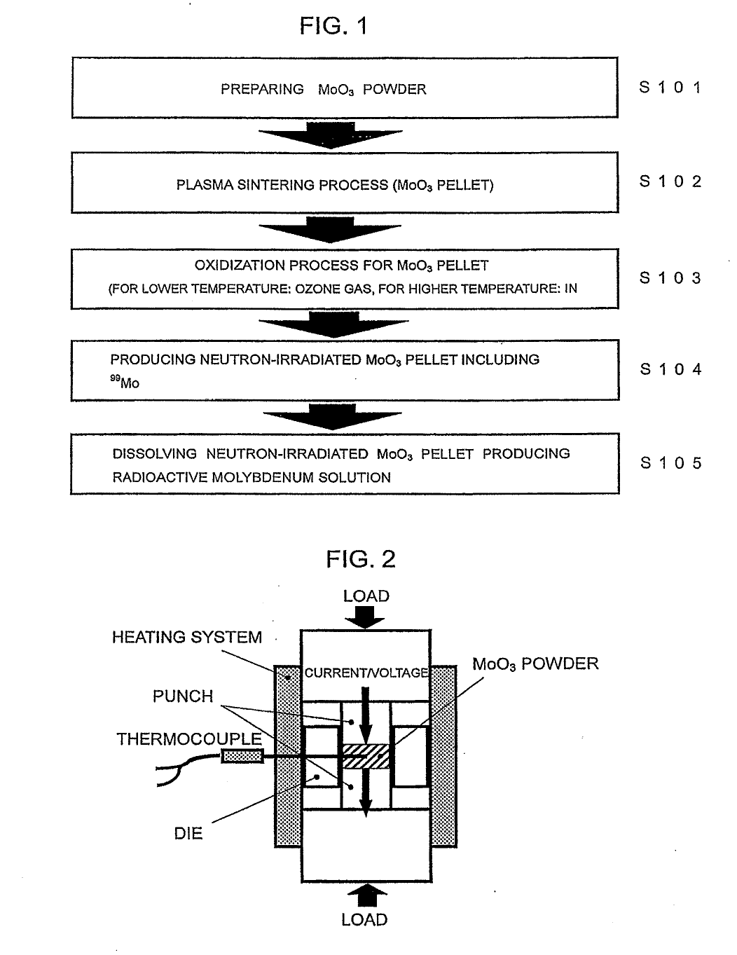

Referring to FIG. 1, the outline of a method of producing radioactive molybdenum (⁹⁹Mo) solution is described. In Step 1, MoO₃ powder is prepared (S101). As for such MoO₃ powder, for example, high-purity MoO₃ powder (99.99% (4N)), MoO₃ powder containing enriched ⁹⁸Mo intended for increasing the amount of produced ⁹⁹Mo and the like may be used. In Step 2, MoO₃ powder is sintered in the air by a plasma sintering method (SPS method or PAS method) in order to obtain high-density MoO₃ pellets (S102). In Step 3, MoO₃ pellets are oxidized in order to reduce the amount of insoluble content in the dissolving process in the final step (S103). In Step 4, oxidized MoO₃ pellets are irradiated with neutrons, for example, in the nuclear reactor in order to produce neutron-irradiated MoO₃ pellets (S104). In the last Step, neutron-irradiated MoO₃ pellets are dissolved in a sodium hydroxide (NaOH) solution in order to obtain radioactive molybdenum solution (S105). The detail of each step will be described below.

Steps 1 though 5 may be performed, for example, at the neutron irradiation facility and its associated facility capable of handling radioactive materials. The obtained radioactive molybdenum solution may be then transferred directly through pipes to the process for extracting ^{99m}Tc, or ⁹⁹Mo may be adsorbed by Mo adsorbent, and then a glass-based column may be filled with Mo adsorbent holding ⁹⁹Mo and inserted in the dedicated container having a shielding function, and then the dedicated container may be delivered to the hospital in order to be used as the radioactive diagnosis drug. In case of large-scale general hospital, it is allowed to provide the hospital with the facility capable of implementing the method of producing radioactive molybdenum according to the present invention. ^{99m}Tc generated by beta-decay may be extracted and used for cancer diagnosis at the hospital, the detail of which is not described here.

### [Fabrication Steps of High-Density MoO₃ Pellets]

By referring to FIG. 2, what will be described next is the step of fabricating high-density MoO₃ pellets by means of plasma sintering method as in Step 2 (S102) shown in FIG. 1. The sintering apparatus, shown in FIG. 2, used for fabricating high-density MoO₃ pellets is composed of a container for storing raw material powder to be filled into the sintering mold, a uniaxial pressing mechanism, a raw material heating system and an electrode system capable of applying a pulsed current, and other mechanisms and systems. The temperature inside the mold may be measured by the thermocouple inserted through holes provided at the mold. Such a sintering apparatus used for a plasma sintering method has been known to those skilled in the art, the structure of which is not described in detail here.

Fabricating of MoO₃ pellets by m ns of a plasma sintering method is advantageously characterized by that the sintering process in the air may be allowed and the reduction action in the sintering process may be made suppressed as much as possible.

Though the sintering process only in the vacuum condition have been employed conventionally in producing MoO₃ pellets by SPS method, the present invention establishes the sintering process in the air by providing a gas flow part capable of importing and carrying the air. An example of the sintering condition of MoO₃ pellet having the dimension of 20×10 mm will be described below. A certain amount of MoO₃ powder may be filled and then pressurized. After pressurization, the temperature is made increase up to a certain sintering temperature while removing the moisture and oxygen exiting on the surface of powder particle by applying a certain level of current, and then upon the temperature reaches a certain level of temperature and keeps its value constant, the temperature may be maintained to be constant for 5 minutes. After completing the above processes, the finished MoO₃ pellets were removed and forwarded to the characteristic evaluation process.

Fabrication of MoO₃ pellets by PAS method is advantageously characterized by that the sintering process in the air has been allowed conventionally, and that applying a pulsed current before the sintering process may bring such an effect that the sintering properties among powder particles may be increased. An example of the sintering condition of MoO₃ pellet having the dimension of φ 20×10 mm will be described below. A certain amount of MoO₃ powder may be filled and then pressurized. After pressurization, a voltage about 2V may be applied in the form of square wave pulse with its width 100 ms for about 30 seconds in the room temperature. Owing to this process, the moisture and oxygen exiting on the surface of powder particle can be removed. Next, the temperature is made increase to a certain level of sintering temperature while applying voltage and current, and then, and then upon the temperature reaches a certain level of temperature and keeps its value constantly, the temperature may be maintained for 5 minutes. After completing the above processes, the finished MoO₃ pellets were removed and forwarded to the characteristic evaluation process.

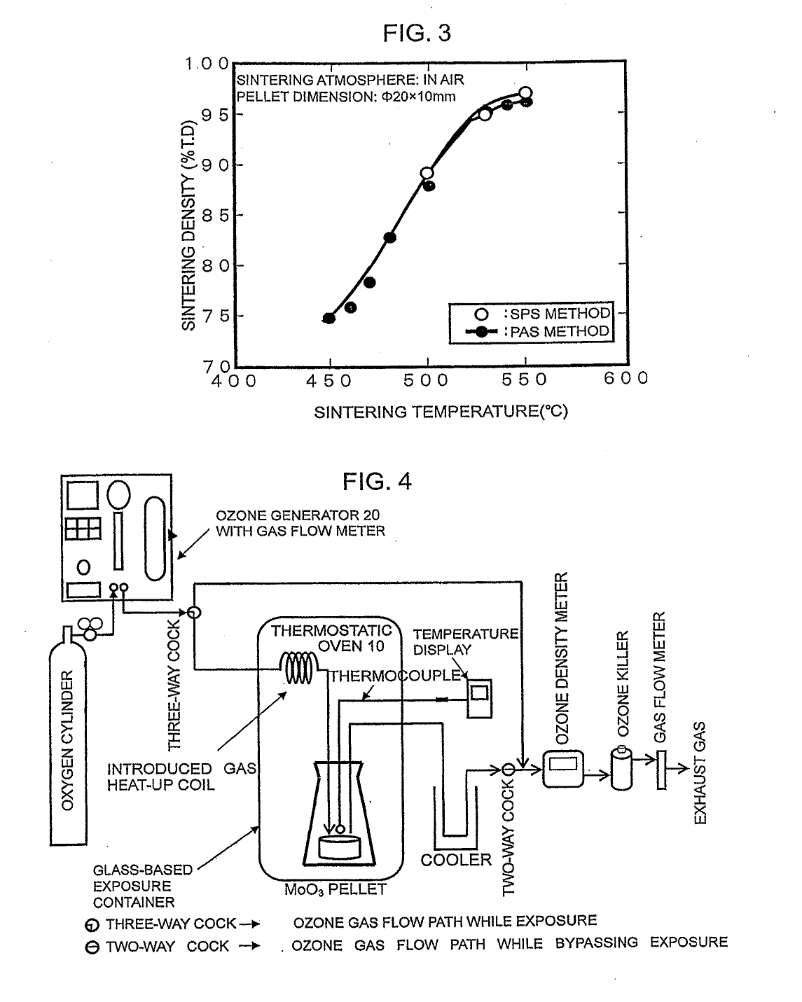

FIG. 3 shows the measurement result of sintering characteristic of MoO₃ pellets so obtained in the production processes for MoO₃ pellets by plasma sintering method, in which the pressure, voltage and current levels are made constant while the sintering temperature is made change as a parameter. FIG. 3 illustrates the sintering-temperature dependency of sintering density in MoO₃ pellets. Based on the data shown in FIG. 4, it is proved that by means of choosing such a process condition that the sintering temperature is made equal to or higher than 500° C. or less than 540° C. in the air for SPS method and PAS method, respectively, high-density MoO₃ pellets with the sintering density being 90% T.D. (Theoretical Density) may be obtained which can provide the amount of produced ⁹⁹Mo about 30% more in contrast to MoO₃ pellets produced by uniaxial pressurization molding method. This means that the target sintering density can be attained with the temperature lower than the temperature described in Patent Document 1.

### [Low-Temperature Ozone Oxidization Process for MoO₃ Pellets]

FIG. 4 shows a schematic diagram of the apparatus for oxidizing MoO₃ pellets with ozone according to the present invention. The oxidizing apparatus includes an ozone generator for accelerating the oxidation of MoO₃ pellets. MoO₃ pellets are inserted into the vessel loaded inside the thermostatic oven for controlling the reaction temperature, which has the structure enable to establish the reaction with ozone by flowing ozone from the ozone generator. Ozone exhausted from the reaction vessel in the thermostatic oven may flow through the ozone monitor and the ozone killer, and finally be exhausted from the apparatus. MoO₃ pellets were oxidized with ozone by using the oxidizing apparatus.

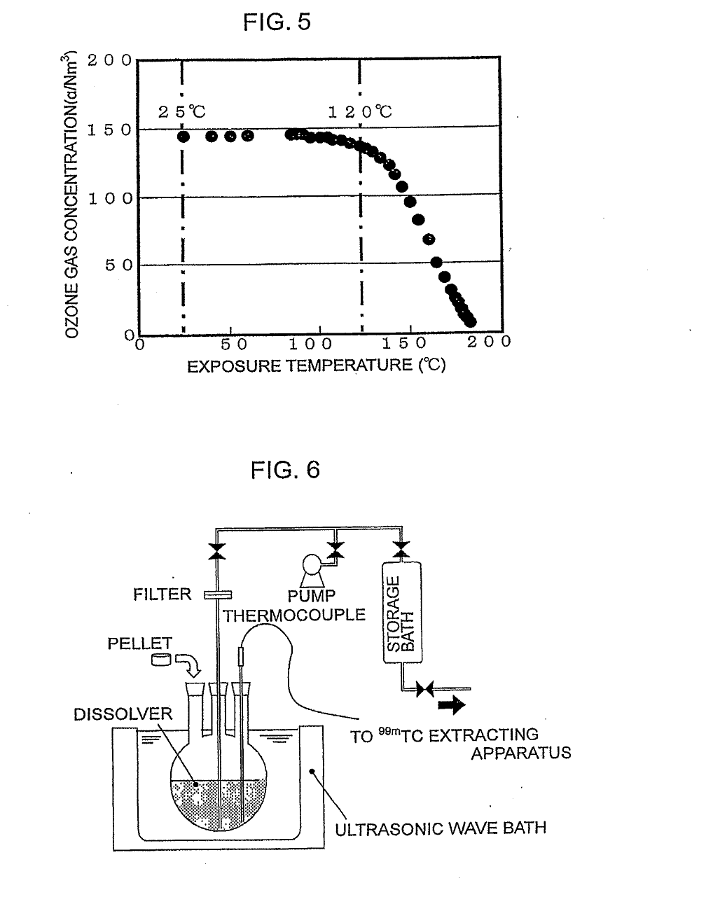

As ozone gas has a strong oxidization capacity, its oxidization reaction has been mainly used for oxidization of organic materials. In contrast, though functional ceramics has been developed recently as inorganic oxide, there is little exemplary experience in using ozone gas for its oxidization process. In studying the oxidization process of ceramics in order to estimate the ozone density dependent of the reaction temperature, the performance of the apparatus according to the present invention was tested (refer to FIG. 5). According to the test result, it is proved that ozone begins to be resolved when the temperature inside the thermostatic oven becomes equal to or higher than 120° C., and that there remains little ozone at about 180° C. and thus, the oxidization effect will disappear.

Based on the test result shown by the graph in FIG. 5, high-density MoO₃ pellets fabricated by plasma sintering method were made oxidized substantially. The conditions for oxidization process are specified as below.

(1) MoO₃ pellets: high-density MoO₃ pellets (about 95% T.D.)
(2) Reaction Duration Time: 1, 2 and 20 hours
(3) Reaction Temperature: room temperature, 50, 80, 100, 120 and 150° C.

High-density MoO₃ pellets fabricated by plasma sintering method were easily oxidized in the exposure temperature range from room temperature to 120° C. It is proved that this oxidization process is almost independent of the exposure temperature but dependent of the ozone gas density. As for the exposure time, the longer the reaction time, the deeper the oxidation process reaches the inside of pellets.

### [Oxidization Process for MoO₃ Pellets in the High-temperature Air]

As the sublimation of MoO₃ starts at the temperature about 650° C. or higher, the condition for the oxidization process in the air for MoO₃ pellets according to the present invention was specified first. MoO₃ pellets may be oxidized in the air in such configuration that MoO₃ pellets are placed on the ceramics-based dish installed inside the electric furnace for controlling the oxidization temperature, and a thermocouple for fabricating the temperature is arranged near MoO₃ pellets.

In general, the oxidization process for ceramics is performed in the oxygen gas or in the air at a higher temperature. However, as for the ceramics sublimated in a lower temperature, the oxidization process for such ceramics in a higher temperature easily affects its sintering density and crystal structure. Therefore, the condition for oxidization process with ozone gas in the lower temperature as described above and also the condition for the higher temperature which is recognized to be important were specified for the oxidization performance test of MoO₃ pellets. The temperature condition for oxidization characteristics test may be specified in terms of the temperature range from 180° C. at which the oxidization effect by using ozone may disappear to 650° C. at which the sublimation of MoO₃ pellets may start, and then high-density MoO₃ pellets fabricated by plasma sintering method were made oxidized substantially in the high-temperature air. The conditions for oxidization process are specified as below.

(1) MoO₃ pellets: high-density MoO₃ pellets (about 95% T.D.)
(2) Reaction Duration Time: 2 hours

### (3) Reaction Temperature: 200, 300, 350, 400, 500, and 600° C.

It was found difficult to oxidize high-density MoO₃ pellets fabricated by plasma sintering method under the condition of the temperature range from 200 to 300° C. and the duration time of 2 hours, and it was also observed that the surface color of MoO₃ pellets does not change significantly at all before and after the oxidization process. In contrast, for MoO₃ pellets fabricated by a plasma sintering method under the condition of the temperature range from 400 to 500° C. and the duration time of 2 hours, it was observed that the surface of MoO₃ pellets changes color to white after the oxidization process. In order to study the boundary temperature between 300 and 400° C. for such color change, the oxidization process was performed under the condition of the temperature at 350° C. and the duration time of 2 hours, it was also observed that the surface of MoO₃ pellets changes color to white after the oxidization process. Based on the measurement of sintering density of MoO₃ pellets and the observation of crystal grain in MoO₃ pellets with the Scanning Electron Microscopy (SEM), it was proved that the sintering density of MoO₃ pellets does not change before and after the oxidization process and also that the growth of crystal grain was not found. In contrast, as for the oxidization process under the condition of the temperature at 600° C., and the duration time of 2 hours, it was observed that the surface of MoO₃ pellets changes color to white and the sintering density does not change, respectively, after the oxidization process, but that the growth of crystal grain was found after the oxidization process for MoO₃ pellets.

As the result of studies as described above, it is proved that ozone gas is a better selection at the lower temperature range, and that the temperature of the oxidization process for high-density MoO₃ pellets may be optimized by selecting to be equal to or higher than the room temperature, or equal to or less than 120° C. in which the ozone gas density does not change. In addition it is proved that the sublimation of MoO₃ never starts in the air at the higher temperature range, and hence that the oxidization process at the higher temperature range may be optimally performed in the temperature range equal to or higher than 350° C., or equal to or less than 500° C. in which MoO₃ is not sublimated in the air and the growth of crystal grain in MoO₃ pellets is not found.

### [Production of Neutron-Irradiated MoO₃ Pellets]

High-density MoO₃ pellets finished with the oxidization process may be loaded in the rabbit and irradiated with neutrons, for example, in the nuclear reactor. As the result, neutron-irradiated MoO₃ pellets including (n, γ)⁹⁹Mo, or simply ⁹⁹Mo, may be produced. As the half-life of ⁹⁹Mo so obtained is as short as about 66 hours, it is required to complete the subsequent dissolving step in a short period of time if at all possible.

[Production of Molybdenum Solution from High-Density MoO₃ Pellets]

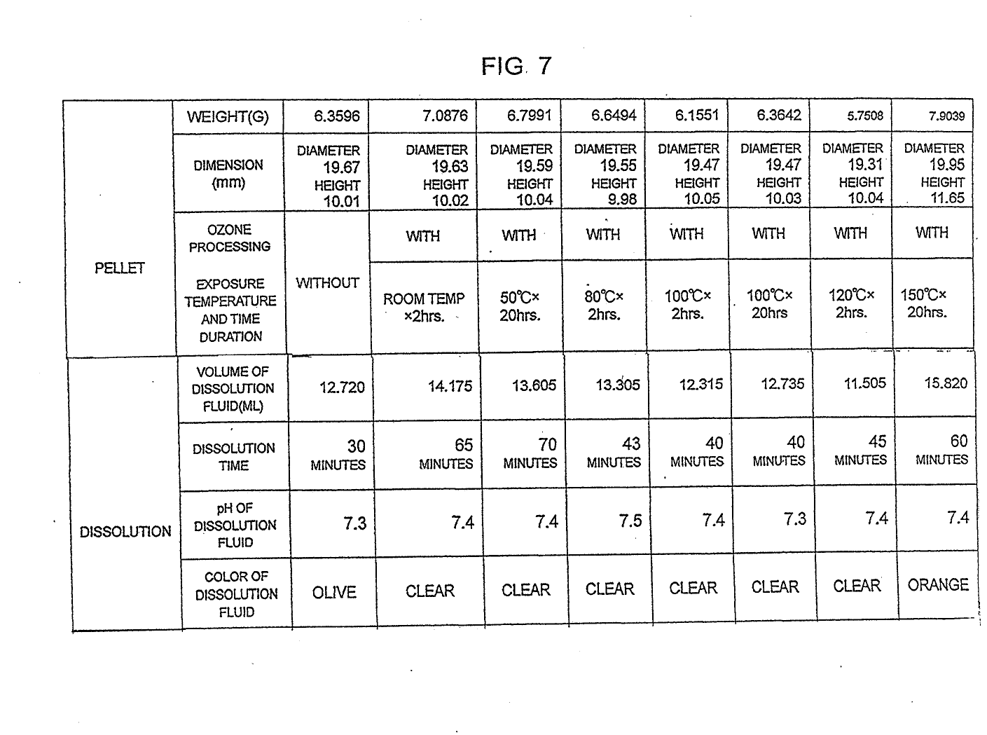

FIG. 6 shows a schematic diagram of the dissolving apparatus for high-density MoO₃ pellets. The dissolving apparatus is provided with an ultrasonic device for accelerating the dissolving process of neutron-irradiated MoO₃ pellets, and a resolver for neutron-irradiated MoO₃ pellets is loaded in the ultrasonic device. What is provided is such a system that radioactive molybdenum solution obtained by dissolving neutron-irradiated MoO₃ pellets may be easily transported via a pump to ^{99m}Tc extraction step. By using the developed dissolving apparatus with an ultrasonic device for MoO₃ pellets, a dissolution test was carried out by using MoO₃ pellets finished with the low-temperature ozone oxidization process and 6M NaOH solution. FIG. 7 shows the dissolution test result. In the dissolution test, the frequency of ultrasonic wave was made 40 kHz, and thus the temperature at the dissolving process increased gradually up to about 60° C. due to the reaction heat caused by the dissolution of MoO₃ pellets in NaOH solution.

After MoO₃ pellets were exposed to ozone gas, MoO₃ pellets were dissolved in 6M NaOH solution. The color of molybdenum solution obtained by dissolving MoO₃ pellets not exposed to ozone gas changes to olive, which demonstrates that insoluble content exists. In contrast, the color of molybdenum solution obtained by dissolving MoO₃ pellets to ozone gas at the temperature at 150° C. changes to pale orange, which demonstrates that an insoluble content still exists though its volume is less than the insoluble content in the molybdenum solution obtained without exposure to ozone gas. As for MoO₃ pellets finished with the oxidization process in the exposure temperature to ozone gas controlled to be from room temperature to 120° C. which does not affect the ozone gas density, the color of molybdenum solution obtained with oxidization process for 2 and 20 hours, respectively, is maintained to be clear in comparison with the molybdenum solution obtained without oxidization process, which demonstrates that no insoluble content exists.

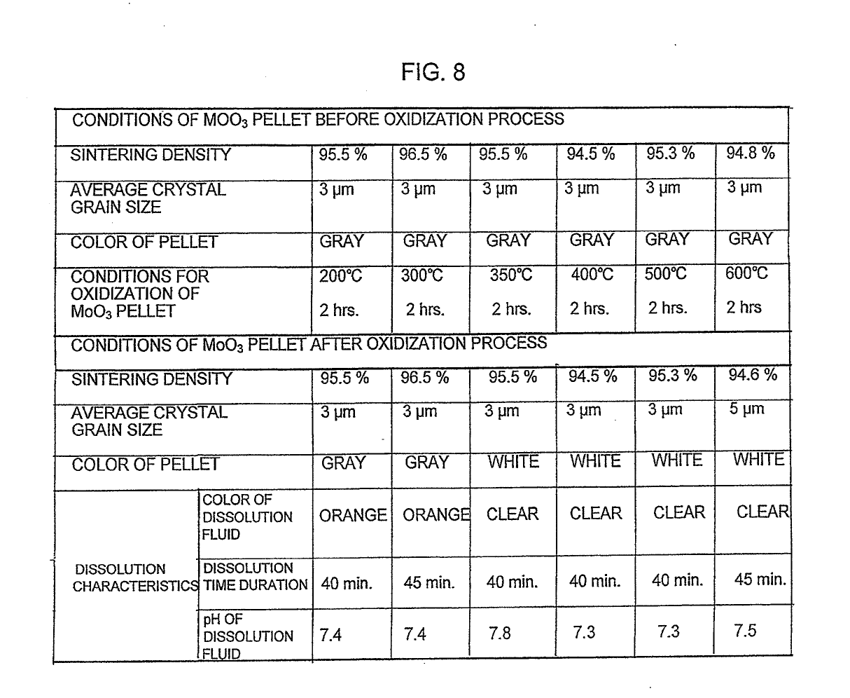

By using a dissolving apparatus with an ultrasonic device for MoO₃ pellets and using 6M NaOH solution, a dissolution test was performed for MoO₃ pellets finished with the oxidization process at a higher temperature in the air under the similar condition to that for MoO₃ pellets finished with the oxidization process at a lower temperature. The test results are shown in FIG. 8 and FIG. 9.

After finishing MoO₃ pellets with oxidization process at a higher temperature in the air, MoO₃ pellets were made dissolved in 6M NaOH solution. The color of molybdenum solution obtained by dissolving MoO₃ pellets not oxidized, and the color molybdenum solution obtained by dissolving MoO₃ pellets finished with the oxidization process at the temperature range from 200 to 300° C. for 2 hours changed to olive, which demonstrates that an insoluble content exists. The color of molybdenum solution obtained by dissolving MoO₃ pellets finished with the oxidization process at the temperature equal to or higher than 350° C. for 2 hours is maintained to be clear, which demonstrates that no insoluble content exists. Note that FIG. 8 only shows that the data for the particle with its average diameter 3 μm and that the same test result was obtained independent of the average particle diameter.

What is claimed is:

1. A method of producing radioactive molybdenum solution comprising a step of preparing MoO₃ powder, a step of fabricating a MoO₃ pellet by filling said MoO₃ powder in a heated die and sintering in an air, a step of oxidizing said MoO₃ pellet, a step of producing neutron-irradiated MoO₃ pellets by irradiating a neutron on said oxidized MoO₃ pellet, and a step of obtaining radioactive molybdenum solution by dissolving said neutron-irradiated MoO₃ pellet.

2. The method of producing radioactive molybdenum solution according to claim 1, wherein said step of oxidizing said MoO₃ pellet is performed by means that said MoO₃ pellet is exposed in ozone gas at a reaction temperature range grater than equal to a room temperature and less than 120° C. or baked preliminarily in an air at a temperature equal to or more than 350° C. and less than 500° C.

3. The method of producing radioactive molybdenum solution according to claim 1, wherein said step of obtaining radioactive molybdenum solution by dissolving said neutron-irradiated MoO₃ pellet is performed by using a dissolving apparatus with ultrasonic device for said neutron-irradiated MoO₃ pellet in 6M NaOH solution.

4. A method of producing radioactive molybdenum solution comprising a step of preparing MoO₃ powder, a step of fabricating a MoO₃ pellet by sintering said MoO₃ powder in a heated die in an air at a temperature equal to or more than 500° C. and less than 540° C. by a plasma sintering method, a step of oxidizing said MoO₃ pellet, a step of producing a neutron-irradiated MoO₃ pellet by irradiating a neutron on said oxidized MoO₃ pellet, and a step of obtaining radioactive molybdenum solution by dissolving said neutron-irradiated MoO₃ pellet.

5. The method of producing radioactive molybdenum solution according to claim 4, wherein said step of oxidizing said MoO₃ pellet is performed by means that said MoO₃ pellet is exposed in ozone gas at a reaction temperature range grater than equal to a room temperature and less than 120° C. or baked preliminarily in an air at a temperature equal to or more than 350° C. and equal to or less than 500° C.

6. The method of producing radioactive molybdenum solution according to claim 4, wherein said step of obtaining radioactive molybdenum solution by dissolving said neutron-irradiated MoO₃ pellet is performed by using a dissolving apparatus with ultrasonic device for said neutron-irradiated MoO₃ pellet in 6M NaOH solution.

7. The method of producing radioactive molybdenum solution according to claim 5, wherein said step of obtaining radioactive molybdenum solution by dissolving said neutron-irradiated MoO₃ pellet is performed by using a dissolving apparatus with ultrasonic device for said neutron-irradiated MoO₃ pellet in 6M NaOH solution.
